(19) United States
(12) Patent Application Publication
(10) Pub. No.: US 2012/0162403 A1
(43) Pub. Date: Jun. 28, 2012

(54) BIOMETRIC AUTHENTICATION SYSTEM

(75) Inventors: Kwang-Hyuk BAE, Seoul (KR); Kyu-Min KYUNG, Seoul (KR); Tae-Chan KIM, Yongin-si (KR)

(73) Assignee: SAMSUNG ELECTRONICS CO., LTD., Suwon-si (KR)

(21) Appl. No.: 13/338,476

(22) Filed: Dec. 28, 2011

(30) Foreign Application Priority Data
Dec. 28, 2010 (KR) 10-2010-0136164

(51) Int. Cl. H04N 7/18

(52) U.S. Cl. 348/77; 348/E07.085

(57) ABSTRACT

A biometric authentication system and apparatus are provided. The system includes an image capture device, a processor and an authentication unit. The image capture device generates first and second biometric data of a user based on reflected infrared light reflected from an object. The processor processes the first and second biometric data to generate first and second feature data. The first feature data is associated with the first biometric data, and the second feature data is associated with the second biometric data. The authentication unit performs authentication of the user based on at least one of the first feature data and the second feature data.

### CROSS-REFERENCE TO RELATED APPLICATION(S)

This application claims priority under 35 U.S.C. §119 from Korean Patent Application No. 10-2010-0136164, filed on Dec. 28, 2010, in the Korean Intellectual Property Office, the contents of which are incorporated by reference herein in its entirety.

### BACKGROUND

1. Field

Systems and apparatuses consistent with exemplary embodiments relate generally to authentication and, more particularly, to a biometric authentication.

2. Description of the Related Art

There are numerous portions of the human body which can be used to differentiate the individual, such as fingerprints and toeprints, retinas of the eyes, facial features, and blood vessels. With advances in biometric technologies in recent years, various devices have been provided which identify biometric features of a portion of the human body to authenticate individuals.

For example, comparatively large amounts of individual characteristic data are obtained from blood vessels in the fingers and hands and from palm-prints. Blood vessel (vein) patterns remain unchanged throughout life from infancy and are regarded as being completely unique, and so are well-suited to individual authentication.

### SUMMARY

One or more exemplary embodiments provide a biometric authentication system, capable of contactlessly performing individual authentication based on a plurality of biometric information.

According to an aspect of exemplary embodiment, there is provided a biometric authentication system including an image capture device, a processor and an authentication unit. The image capture device provides first and second biometric data of a user based on reflected infrared light reflected from an object. The processor processes the first and second biometric data to output first and second feature data. The first feature data is associated with the first biometric data, and the second feature data is associated with the second biometric data. The authentication unit performs an authentication of the user based on at least one of the first and second feature data.

In some exemplary embodiments, the image capture device may be a time of flight (ToF) camera which contactlessly emits infrared light to the object, and receives the reflected infrared light to provide the first and second biometric data. The first biometric data may be depth data of the object, and the second biometric data may be infrared light data of the object.

The processor may include a first processing unit which processes the first biometric data to provide the first feature data; and a second processing unit which processes the second biometric data to provide the second feature data.

The first processing unit may include a coordinate converter which converts the first biometric data to three-dimensional (3D) data in 3D orthogonal coordinates; an alignment and segmentation unit which aligns the 3D data and separates portions corresponding to the object and background in the aligned 3D data to provide a separated data, based on reference data with respect to the object; and a first feature extraction unit which extracts the first feature data from the separated data. The first feature data may be associated with a shape of the object.

The object may be a user's hand, and the second feature data may be vein patterns of a back of the user's hand.

The second processing unit may include a region of interest (ROI) separation unit which separates a ROI data from the second biometric data to provide ROI data, based on a separated data from the first processing unit; and a second feature extraction unit which extracts the second feature data from the ROI data.

The second feature data may be direction components of vein patterns, frequency components of the vein patterns, or both direction components and frequency components, the direction components may be curvature components and angular components of the vein patterns, and the frequency components may be intervals between trunks in the vein patterns.

In some exemplary embodiments, the authentication unit may include a first similarity extraction unit which extracts a first similarity between the first feature data and first registration data to output a first similarity signal; a second similarity extraction unit which extracts a second similarity between the second feature data and second registration data to output a second similarity signal; and an authentication signal generation unit which generates an authentication signal indicating a degree of similarity between the user and the registration data, based on at least one of the first and second similarity signals. The first registration data is associated with the first feature data and the second registration data is associated with the second feature data.

The biometric authentication system may further include a database which stores the first and second registration data.

In some exemplary embodiments, the authentication unit may perform an authentication of the user based on one of the first and second feature data, and the biometric authentication system may be a uni-modal biometric authentication system.

In some exemplary embodiments, the authentication unit may perform an authentication of the user based on the first and second feature data, and the biometric authentication system may be a multi-modal biometric authentication system.

According to an aspect of another exemplary embodiment, there is provided an authentication system including a first image capture device, a second image capture device, a first processor, a second processor and an authentication unit. The first image capture device provides first and second biometric data of a user based on reflected infrared light reflected from an object. The second image capture device provides color data based on reflected visible light from the object. The first processor processes the first and second biometric data to output first and second feature data, the first feature data is associated with the first biometric data, and the second feature data is associated with the second biometric data. The second processor processes the color data to output third feature data, and the third feature data is associated with the color data. The authentication unit performs an authentication of the user based on at least one of the first, second and third feature data.

In some exemplary embodiments, the first image capture device is a ToF camera which contactlessly emits infrared light to the object, and receives the reflected infrared light to provide the first and second biometric data. The second image capture device may be a color camera which receives the reflected visible light to provide the color data.

The second processor may include an ROI separation unit which separates a ROI from the color data to provide a ROI data, based on a separated data from the first processor and a feature extraction unit which extracts the third feature data from the ROI data.

The first processor may process the first and second biometric data further based on the color data from the second processor.

### BRIEF DESCRIPTION OF THE DRAWINGS

Illustrative, non-limiting exemplary embodiments will be more clearly understood from the following detailed description taken in conjunction with the accompanying drawings, in which:

FIG. 1 is a block diagram illustrating an example of a biometric authentication system according to an exemplary embodiment;

FIG. 2 is a graph illustrating first and second biometric data provided by an image capture device of the biometric authentication system of FIG. 1;

FIG. 3 is a block diagram illustrating an example of a first processing unit in FIG. 1 according to an exemplary embodiment;

FIG. 4 is a block diagram illustrating an example of a second processing unit in FIG. 1 according to an exemplary embodiment;

FIG. 5 illustrates the second biometric data according to some exemplary embodiments;

FIG. 6A illustrates three dimensional (3D) data converted from the first biometric data according to an exemplary embodiment;

FIG. 6B illustrates separated data according to an exemplary embodiment;

FIG. 7 illustrates how a region of interest (ROI) is determined according to some exemplary embodiments;

FIG. 8 illustrates the ROI and vein patterns according to some exemplary embodiments;

FIG. 9 is a block diagram illustrating an example of an authentication unit in FIG. 1 according to an exemplary embodiments;

FIG. 10 shows an example of a biometric database file stored in a database in FIG. 1 according to an exemplary embodiment;

FIG. 11 is a block diagram illustrating an example of a biometric authentication system according to another exemplary embodiment;

FIG. 12 is a block diagram illustrating an example of a second processor of the biometric authentication system shown in FIG. 11 according to an exemplary embodiment;

FIG. 13 is a block diagram illustrating an example of an authentication unit in FIG. 11 according to an exemplary embodiment; and

FIG. 14 is a flowchart illustrating a method of biometric authentication according to an exemplary embodiment.

### DETAILED DESCRIPTION OF EXEMPLARY EMBODIMENTS

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein. Rather, these exemplary embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). The term “unit” as used herein means a hardware component or circuit, such as a processor, and/or a software component which is executed by a hardware component or circuit, such as a processor.

The terminology used herein is for the purpose of describing particular exemplary embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

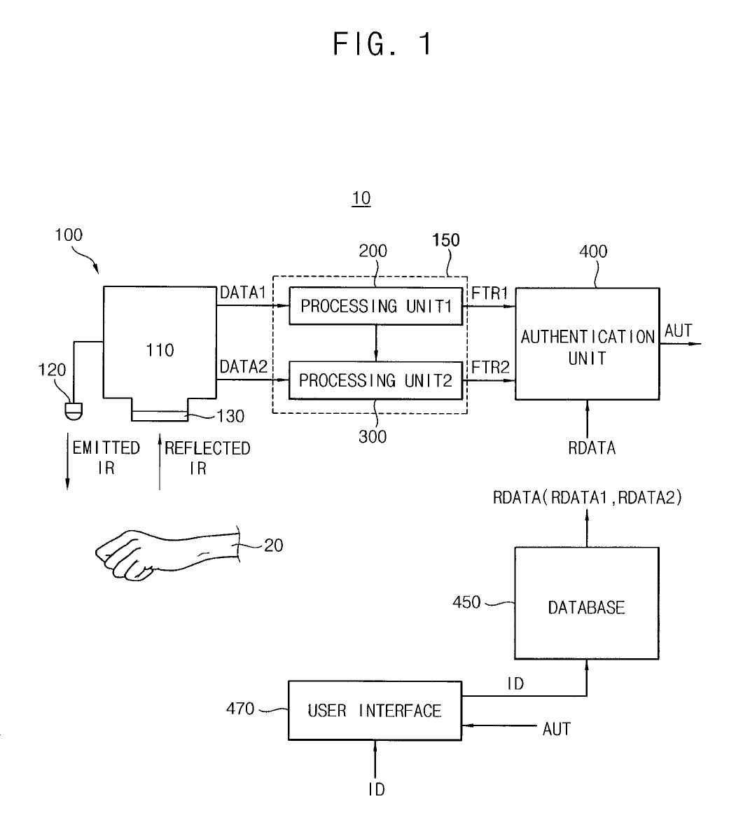

FIG. 1 is a block diagram illustrating an example of a biometric authentication system according to an exemplary embodiment.

Referring to FIG. 1, a biometric authentication system 10 includes an image capture device 100, a processor 150 and an authentication unit 400. In addition, the biometric authentication system 10 may further include a database 450 and a user interface 470.

The image capture device 100 may include a main body 110, an infrared light source 120 and an infrared filter 130. The image capture device 100 emits an infrared light EMITTED IR to an object 20 (e.g., a user's hand) using the infrared light source (such as infrared LED) 120, and receives a reflected infrared light REFLECTED IR from the object 20. The reflected infrared light REFLECTED IR is delivered to the main body 110 through the infrared filter 130, and thus, the main body 110 receives the infrared light.

Hemoglobin in the red corpuscles flowing in the veins has lost oxygen. The hemoglobin (reduced hemoglobin) absorbs near-infrared rays. Consequently, when near-infrared rays are incident on the object 20, reflection is reduced only in the areas in which there are veins, and the intensity of the reflected near infrared rays may be used to identify positions of the veins.

The image capture device 100 processes the reflected infrared light REFLECTED IR to simultaneously output a first biometric data DATA1 and a second biometric data DATA2. The first biometric data DATA1 is depth information with respect to the object 20, and the second biometric data DATA2 is color information with respect to the object 20. For processing the reflected infrared light REFLECTED IR, the main body 110 may include a plurality of pixels and an image processor, although not illustrated. More particularly, the first biometric data DATA1 may be associated with a depth image with respect to the object 20, and the second biometric data DATA2 may be associated with an infrared light image with respect to the object 20.

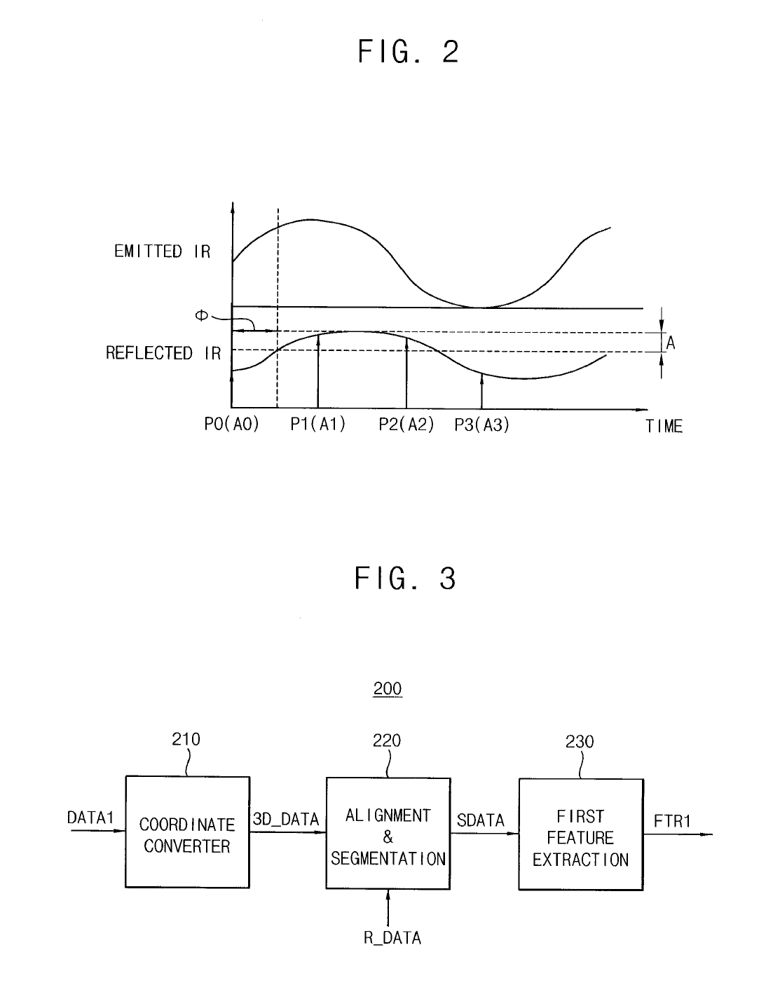

FIG. 2 illustrates the first and second data provided by the image capture device 100.

Referring to FIG. 2, the emitted infrared light EMITTED IR from the light source 120 and the reflected infrared light REFLECTED IR from the object 20 are illustrated.

When the reflected infrared light REFLECTED IR has respective amplitudes A0, A1, A2 A3 at respective points P0, P1, P2 and P3 corresponding to respective angles 0, 90, 180 and 270 degrees, a distance D between the object 20 and the image capture device 100 may be determined by following equation 1.

$$D = \frac{1}{2} c τ = \frac{c}{4 π {f}_{mod}} ϕ = \frac{c}{4 π {f}_{mod}} {tan}^{- 1} ( \frac{{A}_{3} - {A}_{1}}{{A}_{0} - {A}_{2}} ) \qquad [ equation 1 ]$$

Where, fmod denotes a frequency of the emitted infrared light EMITTED IR, and Φ denotes a phase difference between the emitted infrared light EMITTED IR and the reflected infrared light REFLECTED IR.

In addition, amplitude A of the reflected infrared light REFLECTED IR may be determined by following equation 2.

$$A = \frac{\sqrt{{( {A}_{3} - {A}_{1} )}^{2} + {( {A}_{0} - {A}_{2} )}^{2}}}{2} \qquad [ equation 2 ]$$

The first biometric data DATA1 with respect to the depth information of the object 20 may be obtained according to the distance D in the equation 1, and the second first biometric data DATA2 with respect to the infrared light information of the object 20 may be obtained according to the amplitude A in the equation 2.

Referring again to FIG. 1, the processor 150 includes a first processing unit 200 and a second processing unit 300. The processor 150 processes the first and second biometric data DATA1 and DATA2 to generate and output first and second feature data FTR1 and FTR2. The first processing unit 200 processes the first biometric data DATA1 to provide the first feature data FTR1, and the second processing unit 300 processes the second biometric data DATA2 to provide the second feature data FTR2. The first feature data FTR1 may be feature data of the object 20 extracted from the first biometric data DATA1, and the second feature data FTR2 may be feature data of the object 20 extracted from the second biometric data DATA2.

The first feature data FTR1 may be shape features of a back of a user's hand, such as shape of finger joints and directional vector of the back of the user's hand, and the second feature data FTR2 may be associated with vein patterns of the back of the user's hand. More particularly, the second feature data FTR2 may be direction components and/or frequency components of the vein patterns. The direction components may be curvature components and angular components of the vein patterns, and the frequency components may be intervals between trunks in the vein patterns.

The authentication unit 400 performs an authentication of the user based on at least one of the first and second feature data FTR1 and FTR2 to output an authentication signal AUT.

The image capture device 100 may be a ToF camera which contactlessly emits infrared light EMITTED IR to the object 20, and receives the reflected infrared light REFLECTED IR to provide the first and second biometric data DATA1 and DATA2.

The database 450 stores first and second registration data RDATA1 and RDATA2. The first registration data RDATA1 is associated with the first feature data FTR1 and is registered. The second registration data RDATA2 is associated with second feature data FTR2 and is registered.

The user interface 470 receives identification information (ID) from the user and transfers the ID to the database 450. The database 450 provides the authentication unit 450 with records corresponding to the ID of the user as the registration data RDATA including the first and second registration data RDATA1 and RDATA2.

FIG. 3 is a block diagram illustrating an example of the first processing unit 200 in FIG. 1 according to an exemplary embodiment.

Referring to FIG. 3, the first processing unit 200 includes a coordinate converter 210, an alignment and segmentation unit 220 and a first feature extraction unit 230.

The coordinate converter 210 converts the first biometric data DATA1 to 3D data 3D_DATA in 3D orthogonal coordinates. The alignment and segmentation unit 220 aligns the 3D data 3D_DATA and separates portions corresponding to the object and the background in the aligned 3D data 3D_DATA to provide separated data SDATA, based on reference data R_DATA with respect to the object 20. The first feature extraction unit 230 extracts the first feature data FTR1 from the separated data SDATA, and provides the first feature data FTR1 to the authentication unit 400. As mentioned above, the first feature data FTR1 may be shape features of the back of a user's hand, such as shape of finger joints and a directional vector of the back of the user's hand.

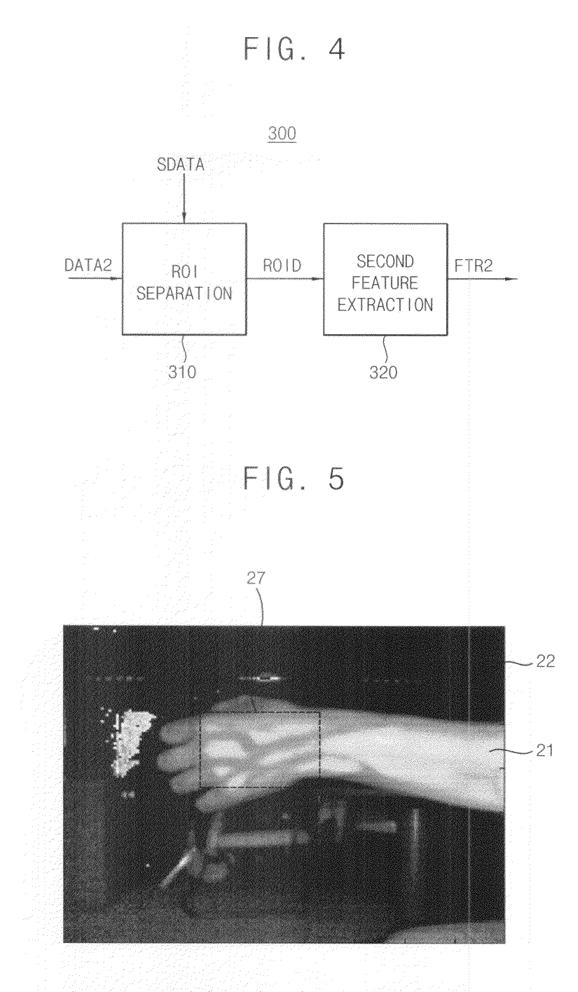

FIG. 4 is a block diagram illustrating an example of the second processing unit 300 in FIG. 1 according to an exemplary embodiment.

Referring to FIG. 4, the second processing unit 300 includes an ROI separation unit 310 and a second feature extraction unit 320.

The ROI separation unit 310 separates ROI data ROID from the second biometric data DATA2, based on the separated data SDATA from the first processing unit 200, to provide the ROI data ROID. More particularly, the ROI separation unit 310 separates the ROI data ROID from the second biometric data DATA2 based on the separated data SDATA from the alignment and segmentation unit 220 in the first processing unit 200 to provide the ROI data ROID. The second feature extraction unit 320 extracts the second feature data FTR2 from the ROI data ROID, and provides the second feature data FTR2 to the authentication unit 400. As mentioned above, the second feature data FTR2 may be direction components and/or frequency components of the vein patterns.

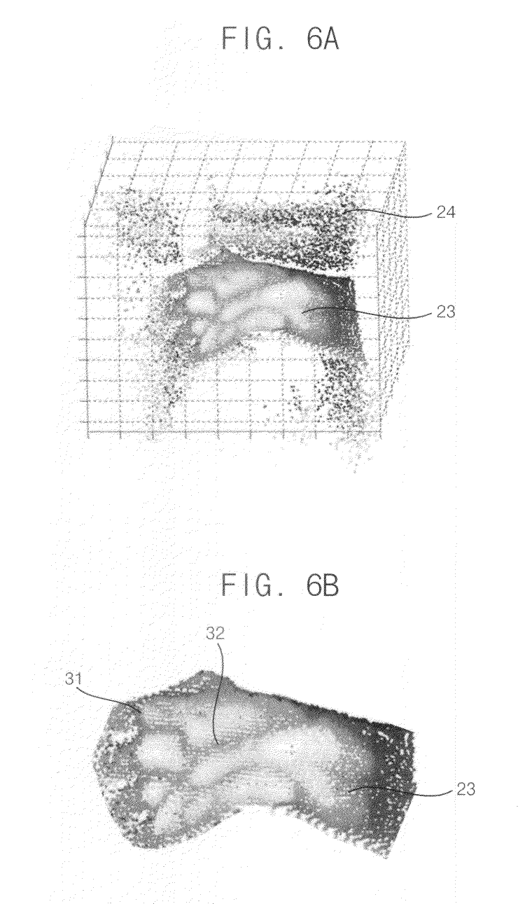

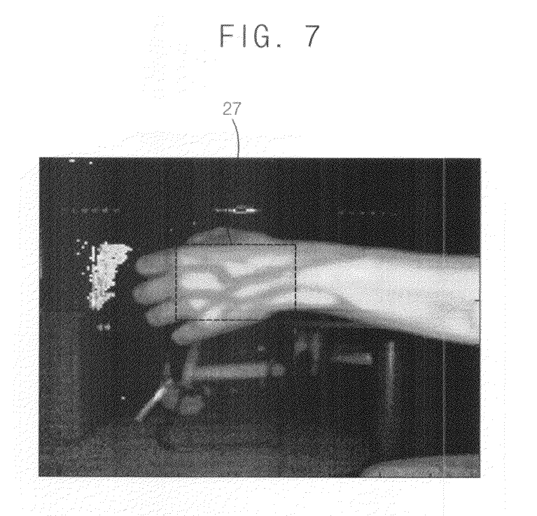

FIG. 5 illustrates the second biometric data according to an exemplary embodiment. FIG. 6A illustrates the 3D data converted from the first biometric data according to an exemplary embodiment. FIG. 6B illustrates the separated data according to an exemplary embodiment.

Referring to FIG. 5, the second biometric data DATA2 includes portions 21 corresponding to the object 20 (foreground area showing hand, wrist, and forearm) and a background portion 22 (surrounding background area).

Referring to FIG. 6A, the 3D data 3D_DATA includes portions 23 corresponding to the object 20 (foreground area) and portions 24 corresponding to the background portion 24 (background area).

Referring to FIGS. 3, 6A and 6B, the alignment and segmentation unit 220 aligns the 3D data 3D_DATA based on the reference data R_DATA of the object 20. The alignment and segmentation unit 220 may align the 3D data 3D_DATA with respect to the reference data R_DATA by rotating or warping the 3D data 3D_DATA. When the 3D data 3D_DATA is aligned, the 3D data 3D_DATA is substantially arranged in same positions and directions as the reference data R_DATA. The reference data R_DATA may be the registration data RDATA registered in advance in the database 450 by the user. The alignment and segmentation unit 220 separates the foreground area 23 corresponding to the object 20 from the background area 24 in the aligned 3D data 3D_DATA by using a filtering algorithm or weighting algorithm, and provides the foreground area 23 corresponding to the object 20 as the separated data SDATA. Since the foreground area 23 corresponding to the object 20, i.e., the separated data SDATA, is aligned to the reference data R_DATA and has 3D information, the foreground area 23 corresponding to the object 20 may be substantially similar to the user's hand. In addition, since the alignment and segmentation unit 220 may align the 3D data 3D_DATA with respect to the reference data R_DATA, the image capture device 100 contactlessly captures the object 20, and there is little limit to location where the object 20 is positioned. The first feature extraction unit 230 extracts the first feature data FTR1 including the shape features of the back of a user's hand, such as shapes of finger joints 31 (including shapes of the finger joints and angles between the finger joints) and/or one or more directional vectors 32 in the back of the user's hand from the separated data SDATA, and provides the first feature data FTR1 to the authentication unit 400.

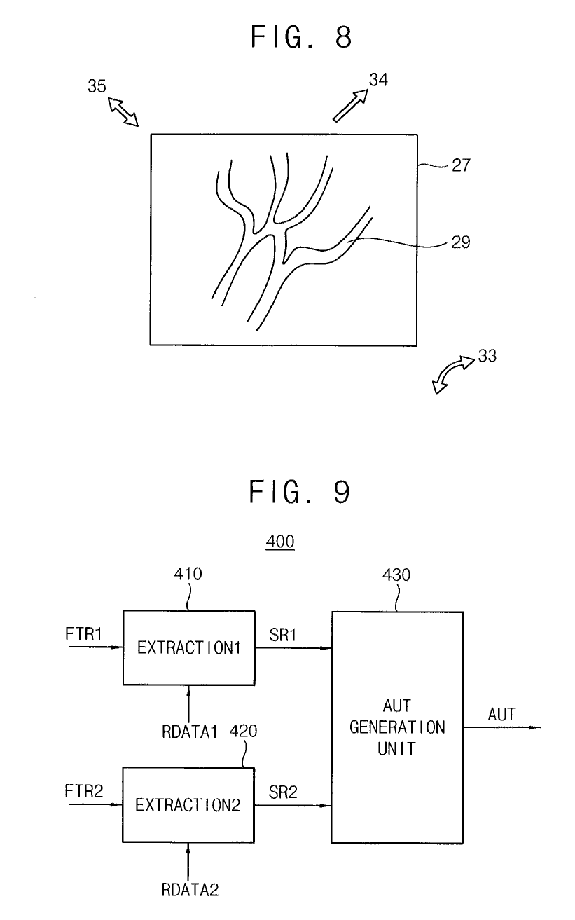

FIG. 7 illustrates how the ROI is determined according to an exemplary embodiment. FIG. 8 illustrates the ROI and the vein patterns according to an exemplary embodiment.

Referring to FIGS. 4, 5, 6B, 7 and 8, the ROI separation unit 310 determines the ROI 27 in the second biometric data DATA2 based on the separation data SDATA and separates the ROI 27 to provide the ROI data ROID to the second feature extraction unit 320. The ROI separation unit 310 may determine the ROI 27 in the second biometric data DATA2 by using a binary weighted algorithm and separate the ROI 27 to provide the ROI data ROID to the second feature extraction unit 320. The second feature extraction unit 320 may extract the second feature data FTR2 from the vein patterns 29 in the ROI data ROID to provide the second feature data FTR2 to the authentication unit 400. As mentioned above, the second feature data FTR2 may be the direction components, such as curvature components 33 and angular components 34 (see FIG. 8) of the vein patterns 29 and/or frequency components, such as intervals between trunks and numbers of trunks 35, of the vein patterns 29.

The directions of the curvature components 33 of the vein patterns 29 may be extracted as a feature without being affected by the inclination of the hand at the time of image capture. In addition, the directions of the angular components 34 of the vein patterns 29 may be extracted as a feature without being affected by instability of the state of the image capture, such as for instance portions missing from the image. In addition, the frequency components 35 of the vein patterns 29 may be extracted as a feature without being affected by a rotation of the blood vessel image. The curvature components 33 may be curvature components in thirty six directions, the angular components 34 may be angular components in eight directions, and the frequency components 35 may be thirty two frequency components. However, the present inventive concept is not limited to this, and the number of components may be more or less. One of ordinary skill in the art will recognize that the number of components will tend to affect accuracy.

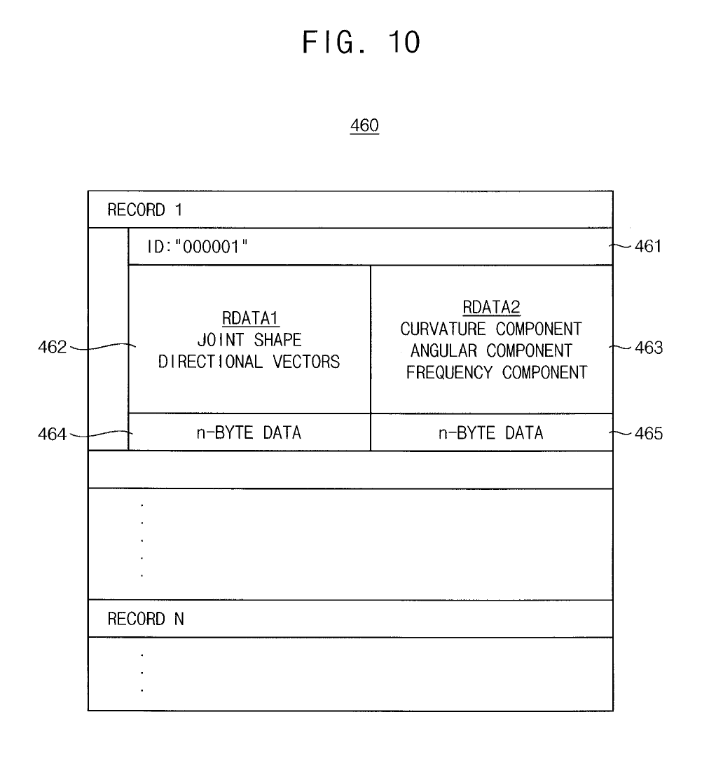

FIG. 9 is a block diagram illustrating an example of the authentication unit in FIG. 1 according to an exemplary embodiment.

Referring to FIG. 9, the authentication unit 400 includes a first similarity extraction unit (EXTRACTION1) 410, a second similarity extraction unit (EXTRACTION2) 420 and an authentication signal generation unit (AUT GENERATION UNIT) 430.

The first similarity extraction unit (EXTRACTION1) 410 compares the first feature data FTR1 and the first registration data RDATA1 and extracts a first similarity between the first feature data FTR1 and the first registration data RDATA1 to output a first similarity signal SR1. In some exemplary embodiments, the first similarity extraction unit 410 may provide the first similarity signal SR1 considering the joint shape 31 and the directional vector 32 of the back of the user's hand (see FIG. 6B).

The second similarity extraction unit (EXTRACTION2) 420 compares the second feature data FTR2 and the second registration data RDATA2 and extracts a second similarity between the second feature data FTR2 and the second registration data RDATA2 to output a second similarity signal SR2. For example, the second similarity extraction unit 420 may provide the second similarity signal SR2 considering at least two of the curvature components 33, the angular components 34 and the frequency components 35 (see FIG. 8).

The first registration data RDATA1 is associated with the first feature data FTR1 of the user and is stored in the database 450. In addition, the second registration data RDATA2 is associated with the second feature data FTR2 of the user and is stored in the database 450. The first and second registration data RDATA1 and RDATA2 are stored in the database 450 through a registration procedure.

In some exemplary embodiments, the first similarity signal SR1 may be a digital signal indicating the first similarity between the first feature data FTR1 and the first registration data RDATA. The first similarity signal SR1 may be a 7-bit digital signal indicating the similarity between the first feature data FTR1 and the first registration data RDATA1 with a percentage %.

In some exemplary embodiments, the second similarity signal SR2 may be a digital signal indicating the second similarity between the second feature data FTR2 and the second registration data RDATA2. The second similarity signal SR2 may be a 7-bit digital signal indicating the similarity between the second feature data FTR2 and the second registration data RDATA2 with a percentage %.

For example, when the first similarity signal SR1 is ‘1100011’, the first similarity between the first feature data FTR1 and the first registration data RDATA1 may be 99%.

In other exemplary embodiments, the first and second similarity signals SR1 and SR2 may be digital signals having 8-bits or more, and may represent the similarity below the decimal point. For example, the first similarity signal SR1 may indicate a similarity of 0.9.

The authentication signal generation unit 430 performs an authentication of the user based on at least one of the first and second similarity signals SR1 and SR2 to output an authentication signal AUT.

In some exemplary embodiments, the authentication signal generation unit 430 may perform an authentication of the user based on only one of the first and second similarity signals SR1 and SR2 to output the authentication signal AUT. In this case, the biometric authentication system 10 is a uni-modal biometric authentication system, and the authentication signal generation unit 430 may output the authentication signal AUT indicating that the user is authenticated when only one of the first and second similarity signals SR1 and SR2 exceeds a reference percentage (for example 98%).

In other exemplary embodiments, the authentication signal generation unit 430 may perform an authentication of the user based on both of the first and second similarity signals SR1 and SR2 to output the authentication signal AUT. In this case, the biometric authentication system 10 is a multi-modal biometric authentication system, and the authentication signal generation unit 430 may provide the user interface 470 with the authentication signal AUT indicating that the user is authenticated when both of the first and second similarity signals SR1 and SR2 exceed a reference percentage (for example 98%).

FIG. 10 illustrates a biometric database file stored in the database 450 in FIG. 1 according to an exemplary embodiment.

Referring to FIG. 10, a biometric database file 460 assigns a first feature data for each user, a second feature data for each user and contents of the first and second feature data to an ID associated with the user, and stores them as a record. That is, the record is divided into an ID 461, contents of the first feature data 462, contents of the second feature data 463, a first feature data 464 and a second feature data 465.

In some exemplary embodiments, the biometric database file 460 does not include the ID 461 of the user. In this case, each of the first and second feature extraction units 410 and 420 compares all of the registration data with the first feature data FTR1 and the second feature data FTR2, and may output the highest similarity as the first and second similarity signals SR1 and SR2. In this case, the user identity ID is not input to the user interface 470.

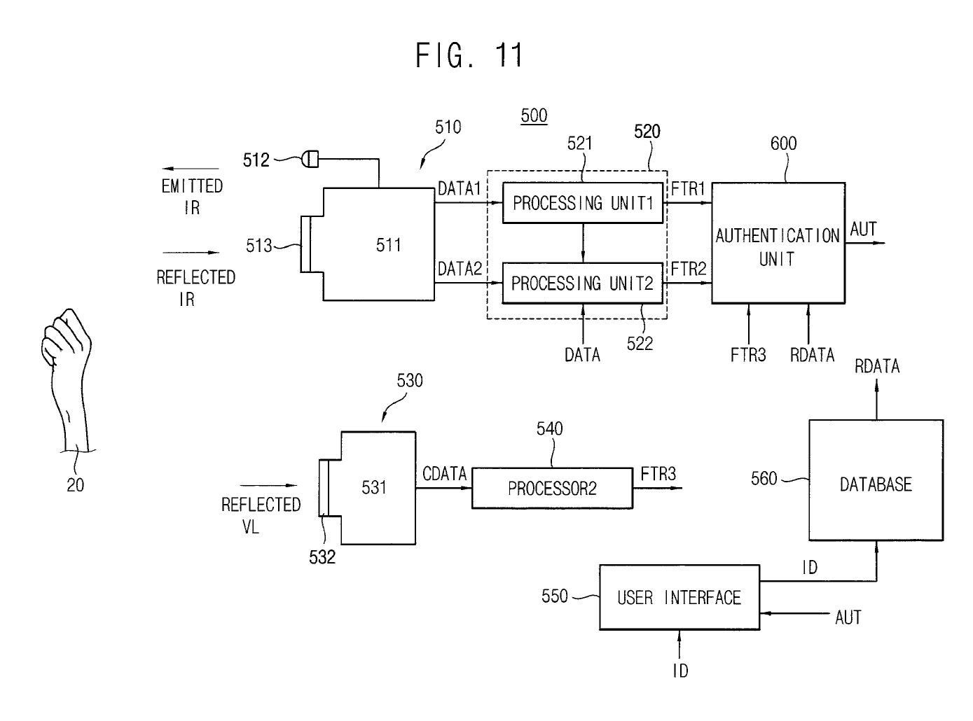

FIG. 11 is a block diagram illustrating an example of a biometric authentication system according to an exemplary embodiment.

Referring to FIG. 11, a biometric authentication system 500 includes a first image capture device 510, a first processor 520, a second image capture device 530, a second processor 540 and an authentication unit 600. In addition, the biometric authentication system 500 may further include a database 560 and a user interface 550.

The first image capture device 510 and the second image capture device 530 may be arranged in parallel along the same axis, and the first image capture device 510 and the second image capture device 530 capture the object 20 on the same axis.

The first image capture device 510 may include a main body 511, an infrared light source 512 and an infrared filter 513. The first image capture device 510 emits an infrared light EMITTED IR to an object 20 (e.g., a user's hand) using the infrared light source (such as infrared LED) 512, and receives a reflected infrared light REFLECTED IR from the object 20. The reflected infrared light REFLECTED IR is delivered to the main body 511 through the infrared filter 513, and thus, the main body 511 receives the infrared light. The first image capture device 510 processes the reflected infrared light REFLECTED IR to simultaneously output a first biometric data DATA1 and a second biometric data DATA2. The first biometric data DATA1 is depth information with respect to the object 20, and the second biometric data DATA2 is color information with respect to the object 20. For processing the reflected infrared light REFLECTED IR, the main body 511 may include a plurality of pixels and an image processor, although not illustrated. More particularly, the first biometric data DATA1 may be associated with depth image with respect to the object 20, and the second biometric data DATA2 may be associated with color image with respect to the object 20.

In other exemplary embodiments, the pixel array in the main body 511 may include depth pixels and may provide black and white image information and distance information with respect to the object 20. In addition, the pixel array may further include color pixels which provide color image information. When the pixel array includes color pixels, the first image capture device 510 may be a 3D color image sensor which simultaneously provides the color image information and the distance information. In some exemplary embodiments, infrared (near infrared) filters may be formed on the depth pixels, and color filters may be formed on the color pixels. In some exemplary embodiments, a ratio of the number of the color pixels and the number of the depth pixels may be changed.

The first processor 520 includes first and second processing units 521 and 522. The first processor 520 processes the first and second biometric data DATA1 and DATA2 to output first and second feature data FTR1 and FTR2. The first processing unit 521 processes the first biometric data DATA1 to provide the first feature data FTR1, and the second processing unit 522 processes the second biometric data DATA2 to provide the second feature data FTR2. The first feature data FTR1 may be feature data of the object 20 extracted from the first biometric data DATA1, and the first feature data FTR2 may be a feature data of the object 20 extracted from the second biometric data DATA2. The first feature data FTR1 may be a shape features of a back of a user's hand, such as a shape of the finger joints and a directional vector of the back of the user's hand, and the second feature data FTR2 may be associated with vein patterns of the back of the user's hand. More particularly, the second feature data FTR2 may be direction components and/or frequency components of the vein patterns. The direction components may be curvature components and angular components of the vein patterns, and the frequency components may be intervals between trunks in the vein patterns.

The first image capture device 510 may be a time of flight (ToF) camera which contactlessly emits infrared light EMITTED IR to the object, and receives the reflected infrared light REFLECTED IR to provide the first and second biometric data DATA1 and DATA2.

The second image capture device 530 may include a main body 531 and a color filter 532. The second image capture device 530 provides a color data CDATA based on a reflected visible light REFLECTED VL from the object 20. The color data CDATA may be a 2D color image with respect to the object 20. The second image capture device 530 may be a 2D color camera which provides a color image with respect to the object 20.

The second processor 540 processes the color data CDATA to output a third feature data FTR3 associated with the color data CDATA.

The authentication unit 600 performs an authentication of the user based on at least one of the first, second and third feature data FTR1, FTR2 and FTR3 to output an authentication signal AUT.

The user interface 550 receives identity information (ID) from the user and transfers the ID to the database 560. The database 560 provides the authentication unit 600 with records corresponding to ID of the user as the registration data RDATA. The database 560 stores first, second and third registration data RDATA1, RDATA2 and RDATA3. The first registration data RDATA1 is associated with the first feature data FTR1 and is registered. The second registration data RDATA2 is associated with second feature data FTR2 and is registered. The third registration data RDATA3 is associated with third feature data FTR3 and is registered.

Configuration and operation of the first processing unit 521 in the first processor 520 are substantially the same as the configuration and operation of the first processing unit 200 in FIG. 3, and thus detailed description on the configuration and operation of the first processing unit 521 will be omitted.

Configuration and operation of the second processing unit 522 in the first processor 520 are substantially the same as the configuration and operation of the second processing unit 300 in FIG. 3, and thus detailed description on the configuration and operation of the second processing unit 522 will be omitted.

In addition, the first processor 520 processes the first and second biometric data DATA1 and DATA2 further based on the color data CDATA from the second image capture device 530.

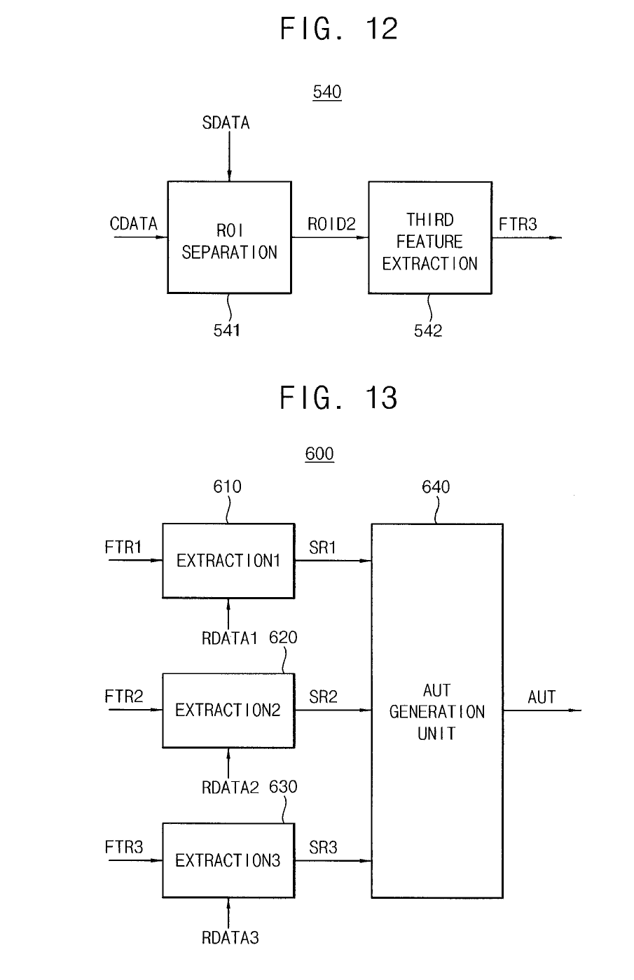

FIG. 12 is a block diagram illustrating an example of the second processor 540 in FIG. 11 according to an exemplary embodiment.

Referring to FIG. 12, the second processor 540 includes a ROI separation unit 541 and a third feature extraction unit 542.

The ROI separation unit 541 separates ROI data ROID from the color data CDATA based on the separated data SDATA from the first processor 521 to provide the ROI data ROID2. The ROI data ROID2 separated from the color data CDATA is a color image. The third feature extraction unit 542 extracts the third feature data FTR3 from the ROI data ROID2 which is a color image, and provides the third feature data FTR3 to the authentication unit 600. The third feature data FTR3 may be a grayscale image of the vein patterns of the object 20 on the ROI data ROID2.

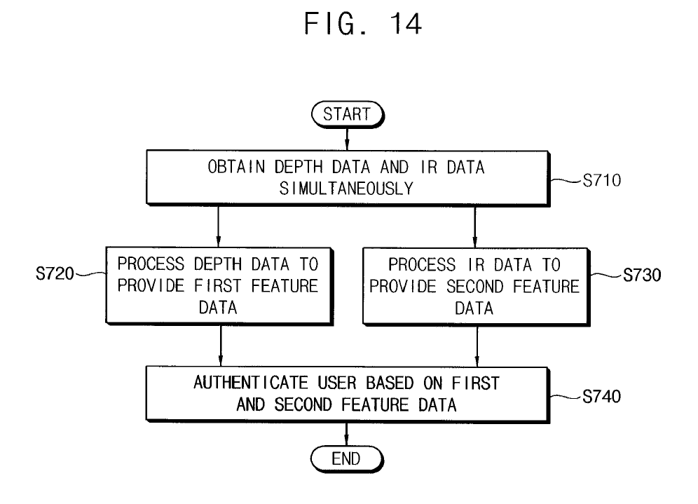

FIG. 13 is a block diagram illustrating an example of the authentication unit 600 in FIG. 11 according to some exemplary embodiments.

Referring to FIG. 13, the authentication unit 600 includes a first similarity extraction unit (EXTRACTION1) 610, a second similarity extraction unit (EXTRACTION2) 620, a third similarity extraction unit (EXTRACTION3) 630 and an authentication signal generation unit (AUT GENERATION UNIT) 640.

The first similarity extraction unit (EXTRACTION1) 610 compares the first feature data FTR1 and the first registration data RDATA1 and extracts a first similarity between the first feature data FTR1 and the first registration data RDATA1 to output a first similarity signal SR1. In some exemplary embodiments, the first similarity extraction unit (EXTRACTION1) 610 may provide the first similarity signal SR1 considering the joint shape 31 and the directional vector 32 of the back of the user's hand as illustrated in FIG. 6B.

The second similarity extraction unit (EXTRACTION2) 620 compares the second feature data FTR2 and the second registration data RDATA2 and extracts a second similarity between the second feature data FTR2 and the second registration data RDATA2 to output a second similarity signal SR2. For example, the second similarity extraction unit (EXTRACTION2) 620 may provide the second similarity signal SR2 considering at least two of the curvature components 33, the angular components 34 and the frequency components 35 as illustrated in FIG. 8.

The third similarity extraction unit (EXTRACTION3) 630 compares the third feature data FTR3 and the third registration data RDATA3 and extracts a third similarity between the third feature data FTR3 and the third registration data RDATA3 to output a third similarity signal SR3. For example, the third similarity extraction unit (EXTRACTION3) 630 may provide the third similarity signal SR3 considering the grayscale of the vein patterns of the object 20 as described above.

The first registration data RDATA1 is associated with the first feature data FTR1 of the user and is stored in the database 560. In addition, the second registration data RDATA2 is associated with the second feature data FTR2 of the user and is stored in the database 560. The third registration data RDATA3 is associated with the third feature data FTR3 of the user and is stored in the database 560. The first, second and third registration data RDATA1, RDATA2 and RDATA3 are stored in the database 560 through a registration procedure.

In some exemplary embodiments, the first similarity signal SR1 may be a digital signal indicating the first similarity between the first feature data FTR1 and the first registration data RDATA1. The first similarity signal SR1 may be 7-bit digital signal indicating the similarity between the first feature data FTR1 and the first registration data RDATA1 with a percentage %.

In some exemplary embodiments, the second similarity signal SR2 may be a digital signal indicating the second similarity between the second feature data FTR2 and the second registration data RDATA2. The second similarity signal SR2 may be 7-bit digital signal indicating the similarity between the second feature data FTR2 and the second registration data RDATA2 with a percentage %.

In some exemplary embodiments, the third similarity signal SR3 may be a digital signal indicating the second similarity between the third feature data FTR3 and the third registration data RDATA3. The third similarity signal SR3 may be 7-bit digital signal indicating the similarity between the third feature data FTR3 and the third registration data RDATA3 with a percentage %.

For example, when the first similarity signal SR1 is ‘1100011’, the first similarity between the first feature data FTR1 and the first registration data RDATA1 may be 99%.

In other exemplary embodiments, the first, second and third similarity signals SR1, SR2 and SR3 may be digital signals having 8-bits or more, and may represent the similarity below the decimal point.

The authentication signal generation unit 640 performs an authentication of the user based on at least one of the first, second and third similarity signals SR1, SR2 and SR3 and outputs the authentication signal AUT.

In some exemplary embodiments, the authentication signal generation unit 640 may perform an authentication of the user based on only one of the first, second and third similarity signals SR1, SR2 and SR3 to output the authentication signal AUT. In this case, the biometric authentication system 500 is a uni-modal biometric authentication system, and the authentication signal generation unit 640 may output the authentication signal AUT indicating that the user is authenticated when one of the first, second and third similarity signals SR1, SR2 and SR3 exceeds a reference percentage (for example 98%).

In other exemplary embodiments, the authentication signal generation unit 640 may perform an authentication of the user based on all of the first, second and third similarity signals SR1, SR2 and SR3 to output the authentication signal AUT. In this case, the biometric authentication system 500 is a multi-modal biometric authentication system, and the authentication signal generation unit 640 may provide the user interface 470 with the authentication signal AUT indicating that the user is authenticated when all of the first, second and third similarity signals SR1, SR2 and SR3 exceed a reference percentage (for example 98%). Alternatively, it is possible to perform authentication of the user based on only two of the first, second, and third similarity signals SR1, SR2, and SR3 to output the authentication signal AUT.

The database 560 may include biometric database files (not illustrated) similar to the biometric database file 460 in FIG. 10. In this case, the biometric database files in the database 560 may further include contents of the third feature data FTR3 in addition to the biometric database files 460 in FIG. 10.

In addition, in another exemplary embodiment, the biometric database files in the database 560 does not include the ID of the user as described with reference to FIG. 10. In this case, each of the first, second and third feature extraction units 610, 620 and 630 compares all of the registration data with the first feature data FTR1, the second feature data FTR2 and the third feature data FTR3, and may output the highest similarity as the first, second and third similarity signals SR1, SR2 and SR3. In this case, the user identity ID is not input to the user interface 550.

One of ordinary skill in the art will recognize that in cases in which three feature extract units 610, 620, and 630 are provided, it is possible to perform the authentication based on only one feature data from one of the units, on all of the features extracted from all of the units, or on any two of the feature data from the units. The number of features used affects the accuracy of the authentication.

FIG. 14 is a flowchart illustrating a method of biometric authentication according to some exemplary embodiments.

Hereinafter, there will be description of a method of biometric authentication with reference to FIGS. 1 and 14.

Depth data (or first biometric data DATA1) and IR (infrared) data (or second biometric data DATA2) are simultaneously obtained using the image capture device 100 (S710). The depth data and the IR data are simultaneously obtained by processing the reflected infrared light REFLECTED IR in the image capture device 100. In addition, the image capture device 100 may be a ToF camera which contactlessly emits infrared light EMITTED IR to the object 20, receives the reflected infrared light REFLECTED IR to provide the depth data DATA1 and the IR data DATA2. The object 20 may be a hand of a user. The depth data DATA1 is processed in the first processing unit 200 in the processor 150 and a first feature data FTR1 is extracted (S720). In addition, the IR data DATA2 is processed in the second processing unit 300 in the processor 150 and a second feature data FTR2 is extracted (S730). The first feature data FTR1 may be shape features of a back of a user's hand, such as a shape of finger joints and a directional vector of the back of the user's hand, and the second feature data FTR2 may be associated with vein patterns of the back of the user's hand. More particularly, the second feature data FTR2 may be direction components and/or frequency components of the vein patterns. The direction components may be curvature components and angular components of the vein patterns, and the frequency components may be intervals between trunks in the vein patterns. Authentication of the user is performed based at least one of the first and second feature data FTR1 and FTR2 (740).

Although the authentication of the user is performed using shape of the back of the user's hand and the vein patterns of the user's hand in the above described exemplary embodiments, the inventive concept may be also applicable to an authentication of the user based on vein patterns of a palm or fingers, palmprints or other biometric features of the user's hand, or based on other parts of the user's body, such as a foot or leg portion. In addition, inventive concept may be also applicable to other biometric authentication such as fingerprints and face recognition.

As mentioned above, since the individual authentication may be contactlessly performed based on at least one of a plurality of biometric features without limitation to locations where the object is placed according to some exemplary embodiments, recognition rate and sanitary degree may be enhanced.

Exemplary embodiments may be applicable to places such as hospitals which require high recognition rate and high sanitary degree.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A biometric authentication system comprising:
an image capture device configured to generate first biometric data of a user and second biometric data of the user, based on reflected infrared light reflected from an object;
a processor configured to receive and process the first and second biometric data to generate first feature data associated with the first biometric data, and second feature data associated with the second biometric data; and
an authentication unit configured to perform authentication of the user based on at least one of the first feature data and the second feature data.

2. The biometric authentication system of claim 1, wherein the image capture device generates the first biometric data and the second biometric data simultaneously.

3. The biometric authentication system of claim 1, wherein the image capture device is a time of flight (ToF) camera configured to emit infrared light to the object, and configured to receive the reflected infrared light reflected from the object to generate the first and second biometric data,
wherein the first biometric data is depth data of the object, and
wherein the second biometric data is infrared light data of the object.

4. The biometric authentication system of claim 1, wherein the processor comprises:
a first processing unit configured to process the first biometric data to generate the first feature data; and
a second processing unit configured to process the second biometric data to generate the second feature data.

5. The biometric authentication system of claim 4, wherein the first processing unit comprises:
a coordinate converter configured to convert the first biometric data to three-dimensional (3D) data in 3D orthogonal coordinates;
an alignment and segmentation unit configured to align the 3D data and configured to separate portions corresponding to the object and a background in the aligned 3D data to provide separated data, based on reference data with respect to the object; and
a first feature extraction unit configured to extract the first feature data from the separated data, the first feature data being associated with a shape of the object,
wherein the object is a hand of the user, and the first feature data is associated with a shape of the hand.

6. The biometric authentication system of claim 5, wherein the second feature data is vein patterns of a back of the hand of the user.

7. The biometric authentication system of claim 6, wherein the second processing unit comprises:
a region of interest (ROI) separation unit configured to separate ROI data from the second biometric data, based on the separated data from the first processing unit; and
a second feature extraction unit configured to extract the second feature data from the ROI data.

8. The biometric authentication system of claim 7, wherein the second feature data is at least one of direction components of the vein patterns, and frequency components of the vein patterns,
wherein the direction components are curvature components and angular components of the vein patterns, and
wherein the frequency components are intervals between trunks in the vein patterns.

9. The biometric authentication system of claim 1, wherein the authentication unit comprises:
a first similarity extraction unit configured to extract a first similarity between the first feature data and first registration data to generate and output a first similarity signal, the first registration data being associated with the first feature data;
a second similarity extraction unit configured to extract a second similarity between the second feature data and second registration data to generate and output a second similarity signal, the second registration data being associated with the second feature data; and
an authentication signal generation unit configured to generate an authentication signal based on at least one of the first similarity signal and the second similarity signal, the authentication signal indicating a degree of similarity between the user and the registration data.

10. The biometric authentication system of claim 9, further comprising:
a database configured to store the first and second registration data.

11. The biometric authentication system of claim 1, wherein the authentication unit performs the authentication of the user based on one of the first feature data and the second feature data, and the biometric authentication system is a uni-modal biometric authentication system.

12. The biometric authentication system of claim 1, wherein the authentication unit performs the authentication of the user based on the first feature data and the second feature data, and the biometric authentication system is a multi-modal biometric authentication system.

13. A biometric authentication system comprising:
a first image capture device configured to generate first biometric data of a user and second biometric data of the user, based on reflected infrared light reflected from an object;
a second image capture device configured to generate color data based on reflected visible light reflected from the object;
a first processor configured to process the first and second biometric data to generate first associated with the first biometric data, and second feature data associated with the second biometric data;
a second processor configured to process the color data to generate a third feature data associated with the color data; and
an authentication unit configured to perform authentication of the user based on at least one of the first feature data, the second feature data and the third feature data.

14. The biometric authentication system of claim 13, wherein the first image capture device is a time of flight (ToF) camera configured to emit infrared light to the object, and configured to receive the reflected infrared light reflected from the object to generate the first and second biometric data, and
wherein the second image capture device is a color camera configured to receive the reflected visible light reflected from the object to generate the color data.

15. The biometric authentication system of claim 13, wherein the second processor comprises:
a region of interest (ROI) separation unit configured to separate ROI from the color data to provide ROI data, based on separated data from the first processor; and
a feature extraction unit configured to extract the third feature data from the ROI data.

16. The biometric authentication system of claim 13, wherein the first processor processes the first and second biometric data further based on the color data from the second processor.

17. The biometric authentication system of claim 12, wherein the first image capture device generates the first biometric data and the second biometric data simultaneously.

18. A biometric authentication apparatus comprising:
an image capture device configured to receive a reflected infrared (IR) signal from a portion of a person, and to provide depth data of the portion of the person and IR data of the portion of the person;
a first processor configured to convert the depth data to three-dimensional data (3D) data, align the 3D data based on reference data, separate the aligned 3D data into object data and background data, and to extract first feature data associated with a shape of the portion of the person from the object data;
a second processor configured to separate a region of interest (ROI) of the portion of the person from IR data using the object data from the first processing unit, and to extract direction components from the ROI, frequency components from the ROI, or both the direction components and the frequency components, as second feature data; and
an authentication unit configured to perform authentication of the person based on at least one of the first feature data and the second feature data.

19. The biometric authentication apparatus of claim 18, wherein the portion of the person is a hand of the person,
the first feature data is associated with a shape of the hand,
the direction components are directions of vein patterns in the hand, and
the frequency components are intervals between trunks of the vein patterns in the hand.

20. The biometric authentication apparatus of claim 19, wherein the authentication unit performs the authentication by comparing the at least one of the first feature data and the second feature data with data of the person that has been registered in advance.
